(19) United States
(12) Patent Application Publication
(10) Pub. No.: US 2025/0190178 A1
(43) Pub. Date: Jun. 12, 2025

(54) ELECTRONIC DEVICE AND CONTROL METHOD THEREOF

(71) Applicants: HYUNDAI MOTOR COMPANY, Seoul (KR); KIA CORPORATION, Seoul (KR)

(72) Inventors: Myeong Gwan Kim, Goyang-si (KR); Ui Jung Jung, Hwaseong-si (KR)

(73) Assignees: HYUNDAI MOTOR COMPANY, Seoul (KR); KIA CORPORATION, Seoul (KR)

(21) Appl. No.: 18/638,038

(22) Filed: Apr. 17, 2024

(30) Foreign Application Priority Data
Dec. 12, 2023 (KR) 10-2023-0180171

(51) Int. Cl. G06F 8/20

(52) U.S. Cl. CPC G06F 8/20

(57) ABSTRACT

An electronic device includes a memory storing computer-executable instructions and at least one processor configured to access the memory and execute the instructions. The at least one processor is configured to identify a target software component (SWC) required to perform a target function in a second automotive open system architecture (AUTOSAR) platform among SWCs for performing a predetermined function in a first AUTOSAR platform. The at least one processor is also configured to apply a target interface used to perform the target function in the first AUTOSAR platform by the target SWC and the target SWC to a wrapper to obtain a conversion SWC capable of performing the target function in the second AUTOSAR platform. The at least one processor is configured to apply the conversion SWC to the second AUTOSAR platform when the conversion SWC is verified through a comparison between the target SWC and the conversion SWC.

### CROSS-REFERENCE TO RELATED APPLICATION

This application claims the benefit of and priority to Korean Patent Application No. 10-2023-0180171, filed on Dec. 12, 2023, the entire contents of which are incorporated herein by reference.

### TECHNICAL FIELD

The present disclosure relates to an electronic device and a control method thereof.

### BACKGROUND

Calculation processing is effectively performed according to changes in vehicle architecture, and an AUTOSAR platform, which is international standards applied for the improvement of development convenience, is applied to a vehicle controller. The AUTOSAR platform may be divided into a classic AUTOSAR platform using a micro control unit (MCU) for satisfying real-time requirements and an adaptive AUTOSAR platform implemented based on a high-performance processor.

Due to the development characteristics of the adaptive AUTOSAR platform, an application software layer (ASW) developer typically has dependencies in a basic software layer (BSW) area. As a result, the development efficiency of adaptive AUTOSAR decreases. Thus, it is difficult to use the reusability of an application, which is one of advantages of the adaptive AUTOSAR. Furthermore, the adaptive AUTOSAR platform and the classic AUTOSAR platform may not use the same software component due to a difference between interfaces. In detail, an AUTOSAR platform developer may not develop an application of another platform, due to understanding (an interface, a module, or the like) of different platforms and a difference in programming language.

### SUMMARY

The present disclosure has been made to solve the above-mentioned problems occurring in the prior art while advantages achieved by the prior art are maintained intact.

Aspects of the present disclosure provide an electronic device and control method for reusing a software component between a first AUTOSAR platform and a second AUTOSAR platform by means of a wrapper.

Aspects of the present disclosure provide an electronic device and a control method for applying a target interface used to perform a target function in a first AUTOSAR platform by a target software component and the target software component to a wrapper to obtain a conversion software component capable of performing the target function in a second AUTOSAR platform. The electronic device and the control method may thus provide various advantages in the automobile industry. The advantages may include, for example, removing hardware dependency in the process of developing an AUTOSAR platform, achieving the simplification of a development procedure depending on the reuse of the software component, and reducing development costs.

Aspects of the present disclosure provide an electronic device and a control method for applying a conversion software component to a second AUTOSAR platform when the conversion software component is verified through a comparison between a target software component and the conversion software component to provide a wrapper such that the function of the target software component, that operates in the first AUTOSAR platform, operates in the second AUTOSAR platform.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, an electronic device is provided. The electronic device includes a memory storing computer-executable instructions and at least one processor configured to access the memory and execute the instructions. The at least one processor is configured to identify a target software component (SWC) required to perform a target function in a second automotive open system architecture (AUTOSAR) platform among SWCs for performing a predetermined function in a first AUTOSAR platform. The at least one processor is also configured to apply a target interface used to perform the target function in the first AUTOSAR platform by the target SWC and the target SWC to a wrapper to obtain a conversion SWC capable of performing the target function in the second AUTOSAR platform. The at least one processor is additionally configured to apply the conversion SWC to the second AUTOSAR platform, based on that the conversion SWC is verified through a comparison between the target SWC and the conversion SWC.

In an embodiment, the at least one processor may be configured to identify first design information of the target SWC for obtaining the conversion SWC, from the target SWC. The at least one processor may also be configured to identify first setting information of the target interface for causing the conversion SWC to be applied to the second AUTOSAR platform, from the target interface. The at least one processor may further be configured to generate the wrapper based on the first design information and the first setting information.

In an embodiment, the at least one processor may be configured to receive a conversion interface capable of being coupled to the conversion SWC in the second AUTOSAR platform, from a user, based on providing the user with the first setting information.

In an embodiment, the at least one processor may be configured to determine a type of the conversion interface for performing the same function as the target interface among interfaces included in the second AUTOSAR platform.

In an embodiment, the at least one processor may be configured to obtain a first sub-output, including at least one of second design information of the conversion SWC, second setting information of the conversion interface, or type information of data used in the conversion interface, or any combination thereof, based on applying the target interface and the target SWC to the wrapper. The at least one processor may also be configured to obtain a second sub-output, including instructions capable of generating the conversion interface from the target interface, based on applying the target interface and the target SWC to the wrapper.

In an embodiment, the at least one processor may be configured to obtain the conversion SWC based on the first sub-output and the second sub-output.

In an embodiment, the at least one processor may be configured to determine first port information including a connection relationship between the target SWC and the target interface. The at least one processor may also be configured to determine second port information including a connection relationship between the conversion SWC and the conversion interface. The at least one processor may further be configured to verify the conversion SWC based on a comparison between the first port information and the second port information.

In an embodiment, the at least one processor may be configured to verify the conversion SWC based on a result of comparing the first design information with the second design information and a result of comparing the first setting information with the second setting information.

In an embodiment, the at least one processor may be configured to determine a grammar format of the conversion SWC, based on a schema version of the second AUTOSAR platform, to verify the conversion SWC.

In an embodiment, the at least one processor may be configured to apply the target interface and the target SWC to the wrapper when the conversion SWC is not verified. The at least one processor may also be configured to identify an alternative SWC different from the target SWC in the first AUTOSAR platform based on a comparison between a number of times the target interface and the target SWC are applied to the wrapper and a predetermined number of times.

According to another aspect of the present disclosure, a control method is provided. The control method includes identifying a target software component (SWC) required to perform a target function in a second automotive open system architecture (AUTOSAR) platform among SWCs for performing a predetermined function in a first AUTOSAR platform. The control method also includes applying a target interface used to perform the target function in the first AUTOSAR platform by the target SWC and the target SWC to a wrapper to obtain a conversion SWC capable of performing the target function in the second AUTOSAR platform. The control method additionally includes applying the conversion SWC to the second AUTOSAR platform when the conversion SWC is verified through a comparison between the target SWC and the conversion SWC.

In an embodiment, obtaining the conversion SWC may include identifying first design information of the target SWC for obtaining the conversion SWC, from the target SWC. Obtaining the conversion SWC may also include identifying first setting information of the target interface for causing the conversion SWC to be applied to the second AUTOSAR platform, from the target interface. Obtaining the conversion SWC may further include generating the wrapper based on the first design information and the first setting information.

In an embodiment, obtaining the conversion SWC may include receiving a conversion interface capable of being coupled to the conversion SWC in the second AUTOSAR platform, from a user, based on providing the user with the first setting information.

In an embodiment, obtaining the conversion SWC may include determining a type of the conversion interface for performing the same function as the target interface among interfaces included in the second AUTOSAR platform.

In an embodiment, obtaining the conversion SWC may include obtaining a first sub-output, including at least one of second design information of the conversion SWC, second setting information of the conversion interface, or type information of data used in the conversion interface, or any combination thereof, based on applying the target interface and the target SWC to the wrapper. Obtaining the conversion SWC may also include obtaining a second sub-output, including instructions capable of generating the conversion interface from the target interface, based on applying the target interface and the target SWC to the wrapper.

In an embodiment, obtaining the conversion SWC may include obtaining the conversion SWC based on the first sub-output and the second sub-output.

In an embodiment, applying the conversion SWC to the second AUTOSAR platform may include determining first port information including a connection relationship between the target SWC and the target interface. Applying the conversion SWC to the second AUTOSAR platform may also include determining second port information including a connection relationship between the conversion SWC and the conversion interface. Applying the conversion SWC to the second AUTOSAR platform may further include verifying the conversion SWC based on a comparison between the first port information and the second port information.

In an embodiment, applying the conversion SWC to the second AUTOSAR platform may include verifying the conversion SWC based on a result of comparing the first design information with the second design information and a result of comparing the first setting information with the second setting information.

In an embodiment, applying the conversion SWC to the second AUTOSAR platform may include determining a grammar format of the conversion SWC, based on a schema version of the second AUTOSAR platform, to verify the conversion SWC.

In an embodiment, the control method may further include applying the target interface and the target SWC to the wrapper when the conversion SWC is not verified. The control method may also include identifying an alternative SWC different from the target SWC in the first AUTOSAR platform based on a comparison between a number of times the target interface and the target SWC are applied to the wrapper and a predetermined number of times.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating an electronic device, according to an embodiment of the present disclosure;

FIG. 2 is a flowchart for describing a control method, according to an embodiment of the present disclosure;

FIG. 3 is a drawing illustrating a relationship among a first AUTOSAR platform, a second AUTOSAR platform, and a software component in an electronic device, according to an embodiment of the present disclosure;

FIG. 4 is a drawing illustrating a method for applying a software component of a first AUTOSAR platform to a wrapper in an electronic device, according to an embodiment of the present disclosure;

FIG. 5 is a drawing illustrating a method for applying a software component of a second AUTOSAR platform to a wrapper in an electronic device, according to an embodiment of the present disclosure;

FIG. 6 is a drawing illustrating a first sub-output and a second sub-output obtained from a wrapper in an electronic device, according to an embodiment of present disclosure;

FIG. 7 is a flowchart for describing a method for applying a conversion software component obtained from a target software component for performing a target function in a first AUTOSAR platform to a second AUTOSAR platform in an electronic device, according to an embodiment of the present disclosure; and

FIG. 8 is a drawing illustrating a computing system associated with an electronic device or a control method thereof, according to an embodiment of the present disclosure.

With regard to description of drawings, the same or similar denotations may be used for the same or similar components.

### DETAILED DESCRIPTION

Hereinafter, embodiments of the present disclosure are described in detail with reference to the accompanying drawings. In adding the reference numerals to the components of each drawing, it should be noted that identical or equivalent components are designated by identical numerals even when the components are displayed on different drawings. In addition, a detailed description of well-known features or functions has been omitted in order not to unnecessarily obscure the gist of the present disclosure. Hereinafter, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure.

Terms such as “first”, “second”, “1^{st}”, “2^{nd}”, or the like may be used in the present disclosure. These terms may be used to refer to various components regardless of the order and/or the priority and to distinguish one component from another component. These terms do not limit the corresponding components irrespective of the nature, order, or priority of the corresponding elements. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It should be understood that when a component (e.g., a first component) is referred to as being “(operatively or communicatively) coupled with/to” or “connected to” another component (e.g., a second component), the component can be directly coupled with/to or connected to the other component or one or more intervening components (e.g., a third component) may be present. In contrast, when a component (e.g., a first component) is referred to as being “directly coupled with/to” or “directly connected to” another component (e.g., a second component), it should be understood that there is no intervening component (e.g., a third component).

When a component, device, element, or the like of the present disclosure is described as having a purpose or performing an operation, function, or the like, the component, device, or element should be considered herein as being “configured to” meet that purpose or perform that operation or function.

According to the situation, the expression “configured to” used in the present disclosure may be used interchangeably with, for example, the expression “suitable for”, “having the capacity to”, “designed to”, “adapted to”, “made to”, or “capable of”.

The term “configured to” should not be interpreted to mean only “specifically designed to” in hardware. For example, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs that store a dedicated processor (e.g., an embedded processor) for performing a corresponding operation or a memory device. Terms used in the present disclosure are used to only describe specified embodiments and are not intended to limit the scope of the present disclosure. The terms of a singular form may include plural forms unless the context clearly indicates otherwise. All the terms used herein, which include technical or scientific terms, may have the same or equivalent meaning that is generally understood by a person having ordinary skill in the art to which the present disclosure pertains. It should be further understood that terms that are defined in a dictionary and commonly used should also be interpreted as is customary in the relevant related art. The terms should not be interpreted in an idealized or overly formal detect unless expressly so defined herein in various embodiments of the present disclosure. In some cases, even when terms are defined in the specification, the terms may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing embodiments of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

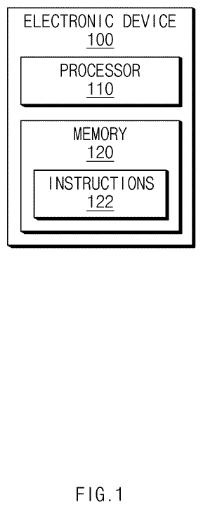

Hereinafter, embodiments of the present disclosure ware described in detail with reference to FIGS. 1-8.

FIG. 1 is a drawing illustrating an electronic device, according to an embodiment of the present disclosure.

An electronic device 100 according to an embodiment may include a processor 110 and a memory 120. The memory 120 may have instructions 122 stored thereon.

The electronic device 100 may refer to a device that applies a target software component for performing a target function in a first automotive open system architecture (AUTOSAR) platform and/or a target interface to a wrapper to obtain a conversion software component applicable to a second AUTOSAR platform.

The first AUTOSAR platform and the second AUTOSAR platform may illustratively include an AUTOSAR software structure that may include an application software layer including a plurality of software components for performing a plurality of predetermined functions. The AUTOSAR software structure may also include a middleware layer for providing an interface for exchanging information between the plurality of software components and a basic software layer. The AUTOSAR platform may be divided into a classic AUTOSAR platform using a micro control unit (MCU) for satisfying a real-time requirement and an adaptive AUTOSAR platform implemented based on a high-performance processor. Illustratively, the first AUTOSAR platform may be the classic AUTOSAR platform. When the first AUTOSAR platform is the classic AUTOSAR platform, the second AUTOSAR platform may be the adaptive AUTOSAR platform. However, the present disclosure is not limited thereto. For example, the first AUTOSAR platform may be the adaptive AUTOSAR platform. When the first AUTOSAR platform is the adaptive AUTOSAR platform, the second AUTOSAR platform may be the classic AUTOSAR platform. Thus, for convenience of description in the specification, a description is provided of an example in which the first AUTOSAR platform is the classic AUTOSAR platform and the second AUTOSAR platform is the adaptive AUTOSAR platform.

The target software component may refer to a basic unit of an application program (i.e., an application) among components that are basic units of the first AUTOSAR platform. For example, the target software component may perform an actuator function, a function associated with a sensor, and the like. The electronic device 100 may identify the target software component required to perform the target function in the second AUTOSAR platform among software components for performing a predetermined function in the first AUTOSAR platform.

The conversion software component may refer to a component that is a basic unit of an application program, among components that are basic units of the second AUTOSAR platform. The conversion software component may include a component for performing the target function of the target software component. The target function may be a function of the target software component. In an example, the electronic device 100 may apply the target software component to the wrapper to obtain the conversion software component. The electronic device 100 may thus obtain a conversion software component from the target software component to apply the target software component, that performs a function in the first AUTOSAR platform, to the second AUTOSAR platform. As a result, the electronic device 100 may apply the target software component to the wrapper to obtain the conversion software component capable of performing the target function, without generating a separate software component capable of performing the target function.

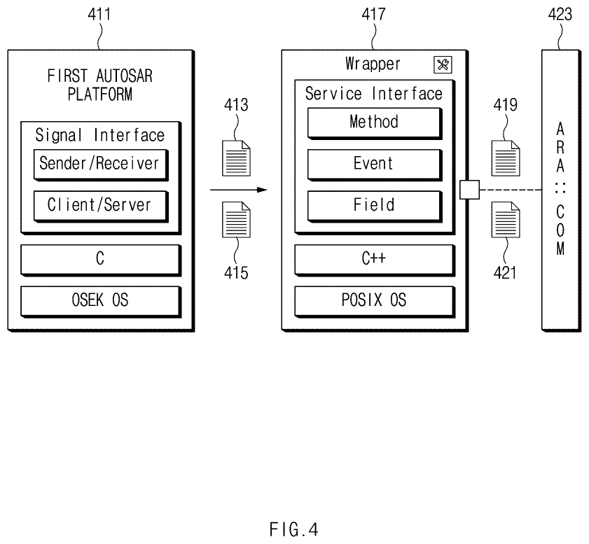

The wrapper may be illustratively a program and/or a processor that convert(s) the software component. In an embodiment, the electronic device 100 may generate the wrapper based on design information of the target software component and setting information of the target interface. The electronic device 100 may apply the target software component and the target interface to the wrapper to obtain the conversion software component. The wrapper, according to an embodiment, is described in more detail below with reference to FIGS. 4-6.

The target interface may refer to an interface used to perform the target function in the first AUTOSAR platform by the target software component. For example, as the target interface connects a port of the target software component and a port of a target with which the target software component communicates, the target software component may perform the target function. Similarly, the conversion interface may refer to an interface used to perform the target function in the second AUTOSAR platform by the conversion software component.

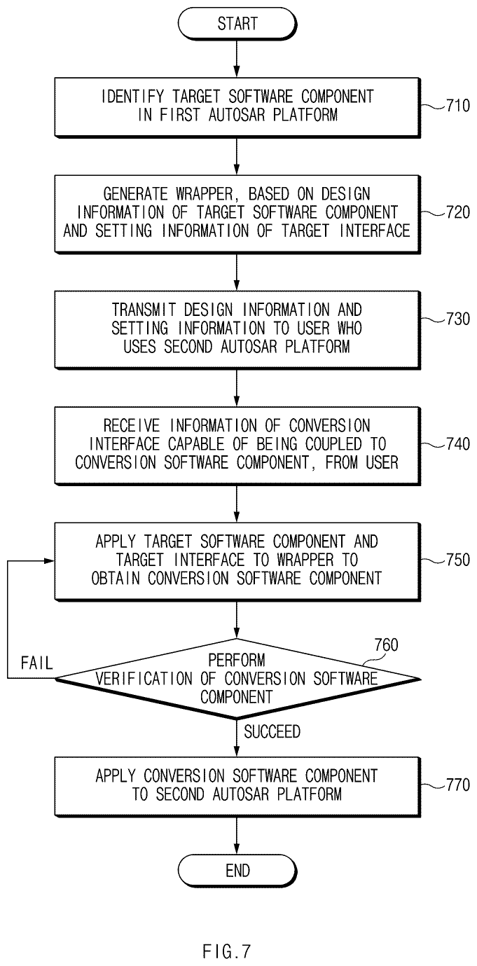

The electronic device 100 may identify the target software component in the first AUTOSAR platform and may apply the target interface and the target software component to the wrapper to obtain the conversion software component. In an embodiment, the electronic device 100 may apply the conversion software component to the second AUTOSAR platform when the conversion software component is verified. The verification of the conversion software component, according to an embodiment, is described in more detail below with reference to FIG. 7.

The electronic device 100 may perform the above-mentioned operations, such that a target developer (e.g., an application software developer) may develop the target software component regardless of a target area (e.g., a basic software area). In an embodiment, the software component and the interface may be dependent on the AUTOSAR platform. For example, interfaces of the first AUTOSAR platform and the second AUTOSAR platform may be different interfaces. The target software component may be coupled to the target interface, but may be not coupled to the conversion interface. Similarly, the conversion software component may be coupled to the conversion interface, but may be not coupled to the target interface. The electronic device 100 may obtain the conversion software component by means of the wrapper, thus enabling the target developer to focus on developing the target software component regardless of the target area.

The processor 110 may execute software instructions and may control at least one other component (e.g., a hardware or software component) connected with the processor 110. In addition, the processor 110 may perform a variety of data processing or calculation operations. In an example, the processor 110 may store the target software component, the target interface, the wrapper, the conversion software component, and the conversion interface in the memory 120.

In an embodiment, the processor 110 may perform all operations performed by the electronic device 100. Therefore, for convenience of description in the specification, the operation performed by the electronic device 100 is generally described as an operation performed by the processor 110. Furthermore, for convenience of description in the specification, the processor 110 is generally described as, but not limited to, one processor. For example, the electronic device 100 may include at least one processor. Each of the at least one processor may perform all operations associated with an operation of obtaining the conversion software component from the target software component.

The memory 120 may temporarily and/or permanently store various pieces of data and/or information required to perform the operation of obtaining the conversion software component from the target software component. For example, the memory 120 may store the target software component, the target interface, the wrapper, the conversion software component, and the conversion interface.

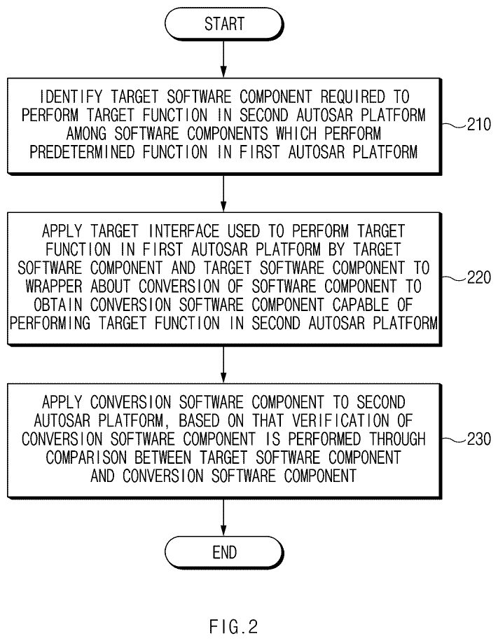

FIG. 2 is a flowchart for describing a control method, according to an embodiment of the present disclosure.

In an operation 210, an electronic device (e.g., the electronic device 100 of FIG. 1) according to an embodiment may identify a target software component required to perform a target function in a second AUTOSAR platform among software components that perform a predetermined function in a first AUTOSAR platform. For example, the electronic device may identify the target software component that performs the target function in the first AUTOSAR platform to perform the target function in the second AUTOSAR platform.

In an operation 220, the electronic device may apply a target interface used to perform the target function in the first AUTOSAR platform by the target software component and the target software component to a wrapper to obtain a conversion software component capable of performing the target function in the second AUTOSAR platform. For example, when the first AUTOSAR platform is a classic AUTOSAR platform, the target interface may include a sender-receiver interface and a client-server interface, and the like. For example, when the second AUTOSAR platform is an adaptive AUTOSAR platform, a conversion interface (e.g., an interface used to perform the target function in the second AUTOSAR platform by the conversion software component) may include a method interface, a fire/forget interface, an event interface, a field interface, a trigger interface, and the like.

In an operation 230, the electronic device may apply the conversion software component to the second AUTOSAR platform when verification of the conversion software component is performed through a comparison between the target software component and the conversion software component. For example, the verification of the conversion software component may include port verification of the conversion software and the conversion interface, verification of a schema version of the conversion software component, verification of a setting of the wrapper, and the like. The verification of the conversion software component, according to an embodiment, is described in more detail below with reference to FIG. 7.

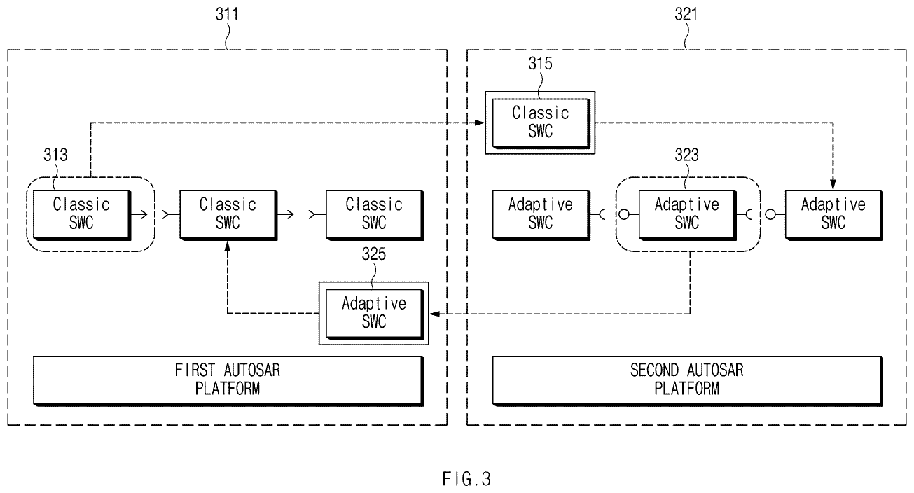

FIG. 3 is a drawing illustrating a relationship among a first AUTOSAR platform, a second AUTOSAR platform, and a software component in an electronic device, according to an embodiment of the present disclosure.

An electronic device (e.g., the electronic device 100 of FIG. 1) according to an embodiment may identify a first AUTOSAR platform 311 and a second AUTOSAR platform 321. In FIG. 3, for convenience of description, the first AUTOSAR platform 311 may be a classic AUTOSAR platform, and the second AUTOSAR platform 321 may be an adaptive AUTOSAR platform.

The first AUTOSAR platform 311 may include a plurality of software components (e.g., shown as Classic SWC in FIG. 3) that performs a predetermined function. The first AUTOSAR platform 311 may connect interfaces to perform communication between software components.

The electronic device may identify a target software component 313 required to perform a target function in the second AUTOSAR platform 321 in the first AUTOSAR platform 311. The electronic device may apply a target interface used to perform the target function in the first AUTOSAR platform 311 by the target software component 313 and the target software component 313 to a wrapper (e.g., not shown) for conversion of a software component. The electronic device may thus obtain a conversion software component 315 capable of performing the target function in the second AUTOSAR platform 321.

The conversion software component 315 may include a function capable of being performed in the first AUTOSAR platform 311. For example, the conversion software component 315 may include the target function of the target software component 313. For example, the conversion software component 315 may indicate a state in which the interface is changed (e.g., the interface used in the first AUTOSAR platform is changed to the interface used in the second AUTOSAR platform) by the wrapper in the target software component 313.

The electronic device may verify the conversion software component 315 based on a comparison between the target software component 313 and the conversion software component 315. The electronic device may apply the conversion software component 315 to the second AUTOSAR platform 321 when the conversion software component 315 is verified. However, the example of the software component and the interface applied to the wrapper by the electronic device is not limited thereto. For example, the electronic device may identify a second target software component 323 required to perform the target function in the first AUTOSAR platform 311 in the second AUTOSAR platform 321. The electronic device may apply the second target software component 323 and a second target interface to the wrapper to obtain a second conversion software component 325. The electronic device may apply the second conversion software component 325 to the first AUTOSAR platform 311 when the second conversion software component 325 is verified.

The electronic device may convert a software component included in the first AUTOSAR platform 311 for compatibility between the first AUTOSAR platform 311 and the second AUTOSAR platform 321. However, the present disclosure is not limited thereto. For example, the electronic device may convert a software component included in the second AUTOSAR platform 321 for compatibility between the second AUTOSAR platform 321 and the first AUTOSAR platform 311.

FIG. 4 is a drawing illustrating a method for applying a software component of a first AUTOSAR platform to a wrapper in an electronic device, according to an embodiment of the present disclosure.

An electronic device (e.g., the electronic device 100 of FIG. 1) according to an embodiment may identify a target software component in a first AUTOSAR platform 411. For example, the electronic device may identify the target software component in an application layer of the first AUTOSAR platform 411. For reference, for convenience of description in FIG. 4, the first AUTOSAR platform 411 may be generally described as a classic AUTOSAR platform and a second AUTOSAR platform 423 may be generally described as an adaptive AUTOSAR platform.

The electronic device may identify first design information 413 of the target software component for obtaining a conversion software component, from the target software component. The electronic device may identify first setting information 415 of a target interface for causing the conversion software component to be applied to the second AUTOSAR platform 423, from the target interface.

The electronic device may generate a wrapper 417 based on the first design information 413 and the first setting information 415. For example, the first design information 413 may include software version information of the target software component, information of the target interface, and information of a data type used in the target interface. For example, the first setting information 415 may include contents (e.g., a target or instructions expressed in a programming language) related to an operation of generating the conversion software component from the target software component. The electronic device may generate the wrapper 417 based on design information (e.g., the first design information 413) of the target software component and setting information (e.g., the first setting information 415) of the target software component. In an embodiment, because the target software component is a component capable of being executed and/or performed in the first AUTOSAR platform 411, the electronic device may generate the wrapper 417 including contents related to the second AUTOSAR platform 423.

The electronic device may receive a conversion interface capable of being coupled to the conversion software component in the second AUTOSAR platform 423, from a user, based on providing the user with the first setting information 415. The electronic device may determine a type of the conversion interface that performs the same function as the target interface among interfaces included in the second AUTOSAR platform 423. In an embodiment, the user may determine and provide at least one of method, event, field interfaces that are candidates of the conversion interface to the electronic device.

The electronic device may apply the target interface and the target software component to the wrapper 417 to obtain a first sub-output 419 and a second sub-output 421. For example, the electronic device may obtain the first sub-output 419 including at least one of second design information of the conversion software component, second setting information of the conversion interface, or type information of data used in the conversion interface, or any combination thereof, based on applying the target interface and the target software component to the wrapper 417. The electronic device may obtain the second sub-output 421, including instructions capable of generating the conversion interface from the target interface, based on applying the target interface and the target software component to the wrapper 417. The electronic device may obtain the conversion software component based on the first sub-output 419 and the second sub-output 421. The electronic device may apply the conversion software component to the second AUTOSAR platform 423 based on verifying the conversion software component. Illustratively, the electronic device may apply the conversion software component to a communication function of an AUTOSAR runtime for adaptive application (ARA) for an adaptive application of the second AUTOSAR platform 423.

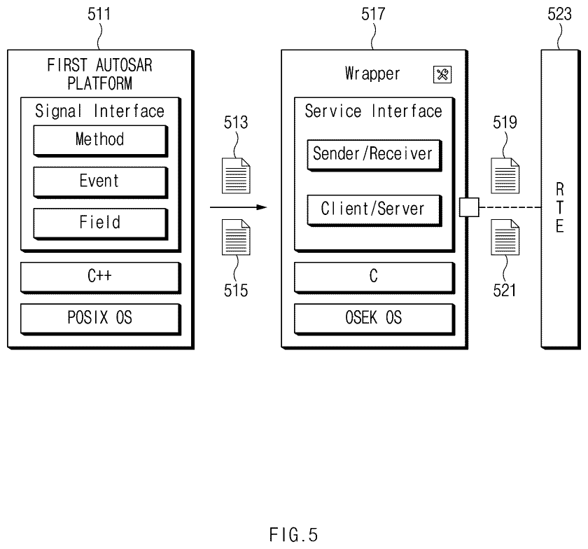

FIG. 5 is a drawing illustrating a method for applying a software component of a second AUTOSAR platform to a wrapper in an electronic device, according to an embodiment of the present disclosure.

An electronic device (e.g., the electronic device 100 of FIG. 1) according to an embodiment may identify a target software component in a first AUTOSAR platform 511. For example, the electronic device may identify the target software component in an application layer of the first AUTOSAR platform 511. For reference, for convenience of description in FIG. 5, the first AUTOSAR platform 511 may be generally described as an adaptive AUTOSAR platform, and a second AUTOSAR platform 523 may be generally described as a classic AUTOSAR platform.

The electronic device may identify first design information 513 of the target software component for obtaining a conversion software component, from the target software component. The electronic device may identify first setting information 515 of a target interface for causing the conversion software component to be applied to the second AUTOSAR platform 523, from the target interface.

The electronic device may generate a wrapper 517 based on the first design information 513 and the first setting information 515. For example, the first design information 513 may include software version information of the target software component, information of the target interface, and information of a data type used in the target interface. For example, the first setting information 515 may include contents (e.g., a target or instructions expressed in a programming language) related to an operation of generating the conversion software component from the target software component. The electronic device may generate the wrapper 517 based on design information (e.g., the first design information 513) of the target software component and setting information (e.g., the first setting information 515) of the target software component. In an embodiment, because the target software component is a component capable of being executed and/or performed in the first AUTOSAR platform 511, the electronic device may generate the wrapper 517 including contents related to the second AUTOSAR platform 523.

The electronic device may receive a conversion interface capable of being coupled to the conversion software component in the second AUTOSAR platform 523, from a user, based on providing the user with the first setting information 515. The electronic device may determine a type of the conversion interface that performs the same function as the target interface among interfaces included in the second AUTOSAR platform 523. In an embodiment, the user may determine and provide at least one of sender-receiver and client-server interfaces that are candidates of the conversion interface to the electronic device.

The electronic device may apply the target interface and the target software component to the wrapper 517 to obtain a first sub-output 519 and a second sub-output 521. For example, the electronic device may obtain the first sub-output 519, including at least one of second design information of the conversion software component, second setting information of the conversion interface, or type information of data used in the conversion interface, or any combination thereof, based on applying the target interface and the target software component to the wrapper 517. The electronic device may obtain the second sub-output 521, including instructions capable of generating the conversion interface from the target interface, based on applying the target interface and the target software component to the wrapper 517. The electronic device may obtain the conversion software component based on the first sub-output 519 and the second sub-output 521. The electronic device may apply the conversion software component to the second AUTOSAR platform 523 based on verifying the conversion software component. Illustratively, the electronic device may apply the conversion software component to an AUTOSAR runtime environment (RTE) of the second AUTOSAR platform 523.

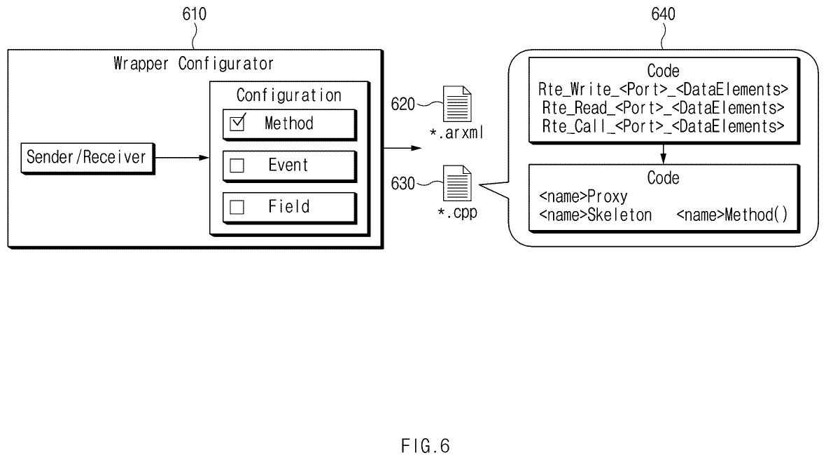

FIG. 6 is a drawing illustrating a first sub-output and a second sub-output obtained from a wrapper in an electronic device, according to an embodiment of present disclosure.

An electronic device (e.g., the electronic device 100 of FIG. 1) according to an embodiment may obtain a conversion software component based on a first sub-output 620 and a second sub-output 630 obtained by applying a target software component to a wrapper 610. For example, the wrapper 610 may determine a type of a conversion interface from a target interface associated with the target software component. In an embodiment, the electronic device may identify first design information of the target software component for obtaining the conversion software component, from the target software component. The electronic device may identify first setting information of the target interface for causing the conversion software component to be applied to a second AUTOSAR platform from the target interface. The electronic device may generate the wrapper 610 based on the first design information and the first setting information. The electronic device may receive a conversion interface capable of being coupled to the conversion software component in the second AUTOSAR platform and/or a type of the conversion interface, from a user, based on providing the user with the first setting information. The electronic device may apply the conversion interface and/or the type of the conversion interface received from the user to the wrapper 610. Illustratively, as shown in FIG. 6, the electronic device may input the conversion interface and/or the type of the conversion interface received from the user to configuration of the wrapper 610 (a portion shown as configuration).

Illustratively, the electronic device may determine a type of the conversion interface (e.g., a method interface in FIG. 6) that performs the same function as the target interface (e.g., a sender-receiver interface in FIG. 6) among interfaces (e.g., method, event, and field interfaces in FIG. 6) included in the second AUTOSAR platform.

The electronic device may obtain the first sub-output 620, including at least one of second design information of the conversion software component, second setting information of the conversion interface, or type information of data used in the conversion interface, or any combination thereof, based on applying the target interface and the target software component to the wrapper 610. For example, the first sub-output 620 may include a basic software configuration file (e.g., *.arxml) storing an attribute value of a basic software component set through an AUTOSAR development support tool.

The electronic device may obtain the second sub-output 630, including instructions capable of generating the conversion interface from the target interface, based on applying the target interface and the target software component to the wrapper 610. For example, the second sub-output 630 may include a configuration file (e.g., *.cpp) related to operations associated with a code 640. In an embodiment, the code 640 may include instructions for implementing operations of generating the conversion interface based on the target interface. The code 640 may be used in the process of verifying the conversion software component. The process of verifying the conversion software component, according to an embodiment, is described in more detail below with reference to FIG. 7.

The electronic device may obtain the conversion software component based on the first sub-output 620 and the first sub-output 630. For example, the electronic device may build the first sub-output 620 and the second sub-output 630 in a second AUTOSAR platform environment to obtain the conversion software component. However, the method for obtaining the conversion software component is not limited thereto. For example, the electronic device may apply the target software component and the target interface to the wrapper 610 to directly obtain the conversion software component from the wrapper 610. In this case, the sub-output 620 and the second sub-output 630 may fail to be obtained or output from the wrapper 610.

FIG. 7 is a flowchart for describing a method for applying a conversion software component obtained from a target software component for performing a target function in a first AUTOSAR platform to a second AUTOSAR platform in an electronic device, according to an embodiment of the present disclosure.

In an operation 710, an electronic device (e.g., the electronic device 100 of FIG. 1) according to an embodiment may identify a target software component in a first AUTOSAR platform. For example, the electronic device may identify the target software component, that performs a target function in the first AUTOSAR platform, to perform the target function in a second AUTOSAR platform.

In an operation 720, the electronic device may generate a wrapper based on design information of the target software component and setting information of a target interface. Because a detailed description of the wrapper, according to embodiments, is provided above with reference to FIGS. 4-6, a detailed description associated with the wrapper is omitted from the description of FIG. 7.

In an operation 730, the electronic device may provide the design information and the setting information to a user who uses the second AUTOSAR platform. For example, the design information may include information related to the target software component and the setting information may include information related to the target interface. The electronic device may provide the design information and the setting information to the user who uses the second AUTOSAR platform to perform the following operations.

In an operation 740, the electronic device may receive information of a conversion interface capable of being coupled to a conversion software component, from the user. Herein, as described above in the operation 730, the user may be the user who uses the second AUTOSAR platform. The electronic device may input the information of the conversion interface to the wrapper based on receiving the information of the conversion interface from the user. The electronic device may input the information of the conversion interface received from the user to the wrapper to set the wrapper which generates the conversion software component.

In an operation 750, the electronic device may apply the target software component and the target interface to the wrapper to obtain the conversion software component. Herein, as described above in operation 740, the wrapper may indicate a wrapper to which the information of the conversion interface received from the user who uses the second AUTOSAR platform is input as a setting.

In an operation 760, the electronic device may perform verification of the conversion software component. For example, the electronic device may perform first verification, second verification, and third verification, as described in more detail below, for the conversion software component. However, the present disclosure is not limited thereto.

Illustratively, the electronic device may determine first port information, including a connection relationship between the target software component and the target interface, in conjunction with the first verification. The electronic device may determine second port information including a connection relationship between the conversion software component and the conversion interface. The electronic device may perform the verification of the conversion software component based on a comparison between the first port information and the second port information. For example, the electronic device may compare pieces of port information of software components to perform the verification of the conversion software component.

Illustratively, the electronic device may perform the verification of the conversion software component based on the result of comparing first design information with second design information (i.e., a comparison of design information between software components) and the result of comparing first setting information with second setting information (i.e., a comparison of setting information between interfaces), in conjunction with the second verification. The electronic device may perform the second verification to verify whether the setting input to the wrapper is reflected in the conversion software component.

Illustratively, the electronic device may determine a grammar format of the conversion software component to perform the verification of the conversion software component, based on a schema version of the second AUTOSAR platform, in conjunction with the third verification.

When the verification performed in the operation 760 succeeds, in an operation 770, the electronic device may apply the conversion software component to the second AUTOSAR platform. Otherwise, when the verification performed in the operation 760 fails (i.e., the verification of the conversion software component is not successful), the electronic device may repeatedly perform the operation 750 of applying the target interface and the target software component to the wrapper. Herein, the electronic device may identify an alternative software component different from the target software component in the first AUTOSAR platform, based on a comparison between the number of times the target interface and the target software component are applied to the wrapper and a predetermined number of times. In an example, when the verification of the conversion software component repeatedly fails, the electronic device may correct the target software component. As a result, the electronic device may perform the above-mentioned operations beginning from the operation 710 shown in FIG. 7.

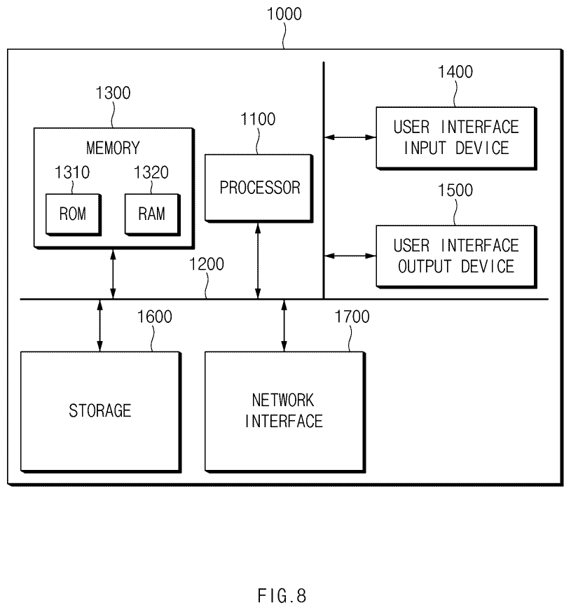

FIG. 8 is a drawing illustrating a computing system associated with an electronic device or a control method thereof, according to an embodiment of the present disclosure.

Referring to FIG. 8, a computing system 1000 for implementing operations of the electronic device or the control method thereof may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments of the present disclosure may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the medium. Alternatively, the storage medium may be integrated with the processor 1100. The processor and the storage medium may reside in an application specific integrated circuit (ASIC). The ASIC may reside within a user terminal. In another embodiment, the processor and the storage medium may reside in the user terminal as separate components.

Hereinabove, although the present disclosure has been described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those having ordinary skill in the art to which the present disclosure pertains. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it should be apparent to one having ordinary skill in the art that the embodiments may be variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

In various embodiment, effects of the electronic device and the control method thereof may be as follows.

According to at least one of embodiments of the present disclosure, an electronic device may apply a target interface used to perform a target function in a first AUTOSAR platform by a target software component and the target software component to a wrapper for conversion of a software component to obtain a conversion software component capable of performing the target function in a second AUTOSAR platform, thus providing various advantages in the automobile industry. The advantages may include, for example, removing hardware dependency in the process of developing an AUTOSAR platform, achieving the simplification of a development procedure depending on the reuse of the software component, and reducing development costs.

Furthermore, according to at least one of embodiments of the present disclosure, the electronic device may apply the conversion software component to the second AUTOSAR platform when the conversion software component is verified through a comparison between the target software component and the conversion software component to provide the wrapper such that the function of the target software component, that operates in the first AUTOSAR platform, operates in the second AUTOSAR platform.

In addition, various effects ascertained directly or indirectly through the present disclosure may be provided.

Therefore, other implementations, other embodiments, and equivalents to claims are within the scope of the following claims.

Therefore, embodiments of the present disclosure are not intended to limit the technical spirit of the present disclosure. Rather, the embodiments are provided only for the illustrative purpose. The scope of the present disclosure should be construed on the basis of the accompanying claims, and all the technical ideas within the scope equivalent to the claims should be included in the scope of the present disclosure.

What is claimed is:

1. An electronic device, comprising:
a memory storing computer-executable instructions; and
at least one processor configured to access the memory and execute the computer-executable instructions,
wherein the at least one processor is configured to:
identify a target software component (SWC) required to perform a target function in a second automotive open system architecture (AUTOSAR) platform among SWCs for performing a predetermined function in a first AUTOSAR platform,
apply a target interface used to perform the target function in the first AUTOSAR platform by the target SWC and the target SWC to a wrapper to obtain a conversion SWC capable of performing the target function in the second AUTOSAR platform, and
apply the conversion SWC to the second AUTOSAR platform when the conversion SWC is verified through a comparison between the target SWC and the conversion SWC.

2. The electronic device of claim 1, wherein the at least one processor is configured to:
identify first design information of the target SWC for obtaining the conversion SWC, from the target SWC;
Identify first setting information of the target interface for causing the conversion SWC to be applied to the second AUTOSAR platform, from the target interface; and
generate the wrapper, based on the first design information and the first setting information.

3. The electronic device of claim 2, wherein the at least one processor is configured to:
receive a conversion interface capable of being coupled to the conversion SWC in the second AUTOSAR platform, from a user, based on providing the user with the first setting information.

4. The electronic device of claim 3, wherein the at least one processor is configured to:
determine a type of the conversion interface for performing a same function as the target interface among interfaces included in the second AUTOSAR platform.

5. The electronic device of claim 4, wherein the at least one processor is configured to:
obtain a first sub-output, including at least one of second design information of the conversion SWC, second setting information of the conversion interface, or type information of data used in the conversion interface, based on applying the target interface and the target SWC to the wrapper; and
obtain a second sub-output, including instructions capable of generating the conversion interface from the target interface, based on applying the target interface and the target SWC to the wrapper.

6. The electronic device of claim 5, wherein the at least one processor is configured to:
obtain the conversion SWC based on the first sub-output and the second sub-output.

7. The electronic device of claim 5, wherein the at least one processor is configured to:
determine first port information including a connection relationship between the target SWC and the target interface;
determine second port information including a connection relationship between the conversion SWC and the conversion interface; and
verify the conversion SWC based on a comparison between the first port information and the second port information.

8. The electronic device of claim 5, wherein the at least one processor is configured to:
verify the conversion SWC based on a result of comparing the first design information with the second design information and a result of comparing the first setting information with the second setting information.

9. The electronic device of claim 1, wherein the at least one processor is configured to:
determine a grammar format of the conversion SWC, based on a schema version of the second AUTOSAR platform, to verify the conversion SWC.

10. The electronic device of claim 1, wherein the at least one processor is configured to:
apply the target interface and the target SWC to the wrapper, when the conversion SWC is not verified; and
identify an alternative SWC different from the target SWC in the first AUTOSAR platform, based on a comparison between a number of times the target interface and the target SWC are applied to the wrapper and a predetermined number of times.

11. A control method, comprising:
identifying a target software component (SWC) required to perform a target function in a second automotive open system architecture (AUTOSAR) platform among SWCs for performing a predetermined function in a first AUTOSAR platform;
applying a target interface used to perform the target function in the first AUTOSAR platform by the target SWC and the target SWC to a wrapper to obtain a conversion SWC capable of performing the target function in the second AUTOSAR platform; and
applying the conversion SWC to the second AUTOSAR platform when the conversion SWC is verified through a comparison between the target SWC and the conversion SWC.

12. The control method of claim 11, wherein obtaining the conversion SWC includes:
identifying first design information of the target SWC for obtaining the conversion SWC, from the target SWC;
identifying setting first information of the target interface for causing the conversion SWC to be applied to the second AUTOSAR platform, from the target interface; and
generating the wrapper, based on the first design information and the first setting information.

13. The control method of claim 12, wherein obtaining the conversion SWC includes:
receiving a conversion interface capable of being coupled to the conversion SWC in the second AUTOSAR platform, from a user, based on providing the user with the first setting information.

14. The control method of claim 13, wherein obtaining the conversion SWC includes:
determining type of the conversion interface for performing a same function as the target interface among interfaces included in the second AUTOSAR platform.

15. The control method of claim 14, wherein obtaining the conversion SWC includes:
obtaining a first sub-output, including at least one of second design information of the conversion SWC, second setting information of the conversion interface, or type information of data used in the conversion interface, based on applying the target interface and the target SWC to the wrapper; and
obtaining a second sub-output, including instructions capable of generating the conversion interface from the target interface, based on applying the target interface and the target SWC to the wrapper.

16. The control method of claim 15, wherein obtaining the conversion SWC includes:
obtaining the conversion SWC based on the first sub-output and the second sub-output.

17. The control method of claim 15, wherein applying the conversion SWC to the second AUTOSAR platform includes:
determining first port information including a connection relationship between the target SWC and the target interface;
determining second port information including a connection relationship between the conversion SWC and the conversion interface; and
verifying the conversion SWC based on a comparison between the first port information and the second port information.

18. The control method of claim 15, wherein applying the conversion SWC to the second AUTOSAR platform includes:
verifying the conversion SWC, based on a result of comparing the first design information with the second design information and a result of comparing the first setting information with the second setting information.

19. The control method of claim 11, wherein applying the conversion SWC to the second AUTOSAR platform includes:
determining a grammar format of the conversion SWC, based on a schema version of the second AUTOSAR platform, to verify the conversion SWC.

20. The control method of claim 11, further comprising:
applying the target interface and the target SWC to the wrapper when the conversion SWC is not verified; and
identifying an alternative SWC different from the target SWC in the first AUTOSAR platform, based on a comparison between a number of times the target interface and the target SWC are applied to the wrapper and a predetermined number of times.
